(19) United States
(12) Patent Application Publication
(10) Pub. No.: US 2011/0209050 A1
(43) Pub. Date: Aug. 25, 2011

(54) System and Method for Presentation Syntax Based Record Capture

(76) Inventor: Wei Lu, Austin, TX (US)

(21) Appl. No.: 12/709,720

(22) Filed: Feb. 22, 2010

(51) Int. Cl. G06F 17/30; G06F 17/00

(52) U.S. Cl. 715/255; 707/790; 707/705; 707/E17.005

(57) ABSTRACT

A system for capturing information associated with a target application includes a resource monitor, a peripheral monitor, and a capture module. The resource monitor is configured to identify an internal resource associated with the target application, and the peripheral monitor is configured to identify peripheral data passing from a peripheral device to the target application. The capture module is configured to receive graphical element descriptors and user data associated with the target application, receive a replica of the internal resource or the peripheral data associated with the target application, and generate a data record including graphical element descriptors, user data, a replica of the internal resource, a replica of the peripheral data, or any combination thereof.

### FIELD OF THE DISCLOSURE

The present disclosure generally relates to electronic records, and more particularly relates to a system and method for presentation syntax based record capture.

### BACKGROUND

Record keeping is an essential part of human activity and civilization. In modern society, records are generated for financial transactions, medical histories, legal documents, education activities, and the like. Additionally, these records may need to be kept and shared for many years.

Medical records are one of the most complex records to keep and share. Keeping and sharing medical records is necessary for diagnosing and treating diseases, as well as preventing illness and improving human health. While medical records have historically been kept on paper, efforts have been made to modernize medical practice by transitioning to electronic medical records (EMR) to enable medical records to be more efficiently shared among medical practitioners treating a patient. Sharing of the medical records can enable the medical practitioners to more effectively coordinate care for the patient. However, vendors of EMR software have tended to specialize on certain areas of medical practices and to cover only common medical occurrences. Furthermore, EMR systems from different vendors may not be able to interoperate, inhibiting the sharing of medical records among medical practitioners using different EMR systems.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a system for capturing electronic records in accordance with an embodiment of the present disclosure;

FIG. 2 is a block diagram illustrating a system for displaying electronic records in accordance with an embodiment of the present disclosure;

FIG. 3 is a flow diagram illustrating an exemplary method of capturing and displaying electronic records in accordance with an embodiment of the present disclosure; and

FIG. 4 is an illustrative embodiment of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

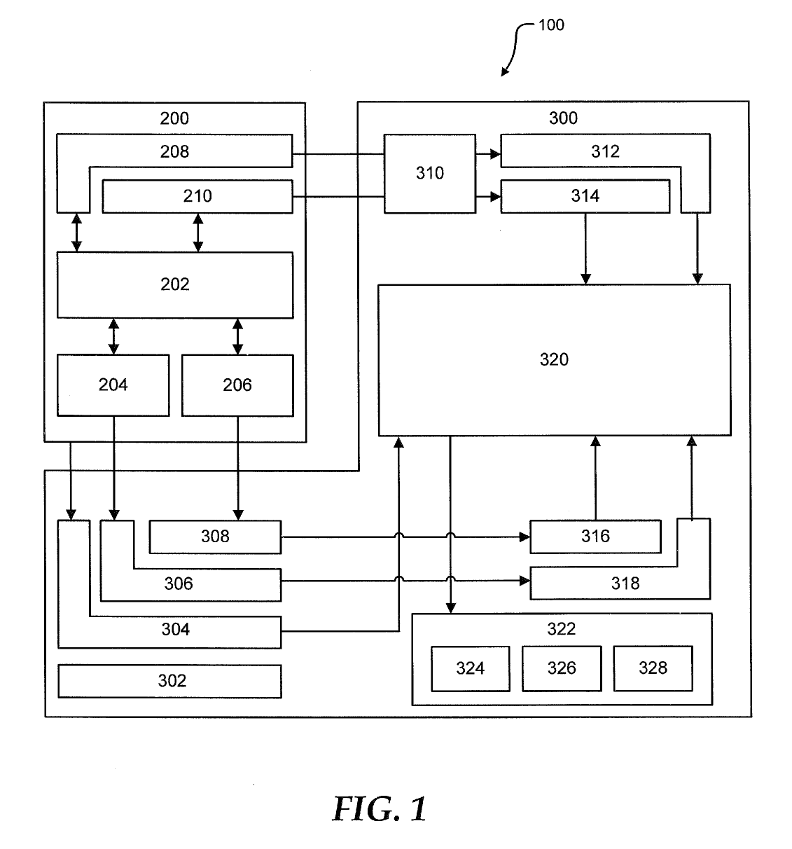

FIG. 1 shows a Presentation Syntax Based Record Capture (PSRC) System 100. The PSRC System 100 includes a Record Keeping Application 200 and a PSRC Application 300.

Record Keeping Application 200 can provide access to a collection of records. Access to the collection of records can include creating a record, editing a record, displaying a record, or any combination thereof. In an embodiment, the collection of records can be stored in a database, such as a local or remote database.

The Record Keeping Application 200 can include an Application Logic Engine 202, a Peripheral Interface Module 204, a System Resource Deposit 206, a User Interface Element Tree 208, and a User Data Container 210.

Application Logic Engine 202 can connect and control Peripheral Interface Module 204, System Resource Deposit 206, User Interface Element Tree 208, and User Data Container 210.

Peripheral Interface Module 204 can communicate and exchange data with external hardware devices such as scanners, printers, video cameras, external storages, or any combination thereof. System Resource Deposit 206 can hold system resources used by Record Keeping Application 200. Examples of system resources can include a file system, memory, a network connection, a clipboard, and the like.

User Interface Element Tree 208 can include the graphical elements used by Record Keeping Application 200 along with information about the hierarchical tree organization of the graphical elements. User Data Container 210 can contain application specific data associated with User Interface Element Tree 208. For example, the User Data Container 210 can include a full name string associated with user interface widget for inputting or displaying a name of a person associated with the record.

In an exemplary embodiment, a user can type a full name into patient name text field maintained by User Interface Element Tree 208. Application Logic Engine 202 can store the input string into User Data Container 210. In another embodiment, a user can click a “show x-ray” button contained in User Interface Element Tree 208. In response, Application Logic Engine 202 can retrieve a file identifier from User Data Container 210 and request System Resource Deposit 206 to open a corresponding x-ray file identified by the file identifier. Further, the Application Logic Engine 202 can display the contents of the x-ray file in a drawing widget maintained in User Interface Element Tree 208. Alternatively, if the x-ray file is on an external storage device, Application Logic Engine 202 can instruct Peripheral Interface Module 204 to transfer the x-ray content from external storage to the drawing widget.

PSRC Application 300 can include a Configuration Module 302, an Application Monitor 304, a Peripheral Monitor 306, a System Resource Monitor 308, a Connector Module 310, a User Interface Element Tree Reference 312, a User Data Container Reference 314, a System Resource Data Replica 316, a Peripheral Data Replica 318, a Control Logic Engine 320, and a Description File 322.

Configuration Module 302 can maintain a list of applications that PSRC Application 300 may capturing record data from. In an embodiment, the list can be created by reading a pre-defined list of applications, such as from a configuration file. Additionally, the list can be dynamically generated from a list of applications currently running on a client device based on confirmation from a user.

Application Monitor 304 can identify when an application that is listed by Configuration Module 302, such as Record Keeping Application 200, is running on the client device. Further, Application Monitor 304 can notify Control Logic Engine 320 when Record Keeping Application 200 is identified.

Peripheral Monitor 306 can identify peripheral logic links opened by the Record Keeping Application 200. Further, Peripheral Monitor 306 can track data being transferred over the logic links. When Control Logic Engine 320 requests a copy of the data associated with the peripheral logic link, the Peripheral Monitor 306 can provide a copy of the peripheral data to be stored in Peripheral Data Replica 318.

System Resource Monitor 308 can identify resources allocated by Record Keeping Application 200 and can maintain a table of references to the resource. When Control Logic Engine 320 requests a copy of the data associated with the system resource, System Resource Monitor 308 can provide a copy of the data to be stored in System Resource Data Replica 316.

Connector Module 310 can establish a communication channel with Record Keeping Application 200. PSRC Application 300 can use the communication channel to obtain information about User Interface Element Tree 208 and User Data Container 210. Depending on client device's operating system (OS) and the type of record keeping application, different techniques can be employed by the connector module. For example, when the client device is running Microsoft Windows and Record Keeping Application 200 is a Windows client application, then Connector Module 310 can use the Microsoft Active Accessibility Application Programming Interface (API) to communicate with Record Keeping Application 200. In another example, when the client device is running Mac OS X and Record Keeping Application 200 is a Mac OS client application, Connector Module 310 can use the Mac OS X Accessibility API to communicate with Record Keeping Application 200. In yet another embodiment, when Record Keeping Application 200 is a browser based web application, then connector module can use Accessible Rich Internet Applications to communicate with the web application.

User Interface Element Tree Reference 312 can store all the necessary structural information about User Interface Element Tree 208 constructed by Record Keeping Application 200. Through Connector Module 310, Control Logic Engine 320 can send queries to Record Keeping Application 200 and Record Keeping Application 200 can provide the structural information about User Interface Element Tree 208 to be stores in the User Interface Element Tree Reference 312.

User Data Container Reference 314 can hold internal user data identifications (IDs) to the user data stored in User Data Container 210 inside Record Keeping Application 200. Control Logic Engine 320 can obtain the user data IDs from Record Keeping Application 200 via Connector Module 310.

System Resource Data Replica 316 can store a copy of the data referenced by Resource Monitor 308. PSRC Application 300 can generate the copy of the data when a user decides to capture a record being displayed by Record Keeping Application 200. While Resource Monitor 308 can retain references to all of the resource data associated with Record Keeping Application 200, PSRC Application 300 may copy only the resource data being used for a displayed record to System Resource Data Replica 316.

Peripheral Data Replica 318 can store a copy of the peripheral data referenced by the Peripheral Interface Monitor 204. Similar to System Resource Data Replica 316, PSRC Application 300 may copy only the peripheral data being used for the displayed record to Peripheral Data Replica 318.

Control Logic Engine 320 can manage the operations executed by PSRC Application 300. Control Logic Engine 320 can control operational procedure of individual modules in the application. Control Logic Engine 320 can coordinate interactions among different modules. Control Logic Engine 320 can also coordinate the interactions between the user and PSRC Application 300. For example, Control Logic Engine 320 can prompt a user for confirmation of a monitored application and can accept a request for capturing a record. In addition to these control functions, Control Logic Engine 320 can generate and save description files, such as Description File 322, of captured records. Additionally, Control Logic Engine 320 can load and replay the captured records back to the user from a saved description files.

Description File 322 can include a Graphical Element Tree Description 324, a User Data Store 326, and an Application Resource Data Store 328. When a user instructs the Control Logic Engine 320 to capture a record that is currently displayed by Record Keeping Application 200, Control Logic Engine 320 can generate Description File 322 by gathering the information and data collected in User Interface Element Tree Reference 312, User Data Container Reference 314, System Resource Data Replica 316, and Peripheral Data Replica 318. Data from User Interface Element Tree Reference 312 can be stored in Graphical Element Tree Description 324. Data from User Data Container Reference 314 can be stored in User Data Store 326. Data from System Resource Data Replica 316 and Peripheral Data Replica 318 can be stored together in Application Resource Data Store 328.

Additionally, Control Logic Engine 320 may generate metadata associated with the captured record. For example, the metadata can include a name, such as a patient name, associated with the record, the time and date the record was captured, an identifier for Record Keeping Application 200, an identifier for the user who initiated the capture, a description of the record, and the like.

In an embodiment, Description File 322 can be a single file containing the metadata, Graphical Element Tree Description 324, User Data Store 326, and Application Resource Data Store 328. In another embodiment, Description File 322 can include the metadata and links to separate files containing Graphical Element Tree Description 324, User Data Store 326, and Application Resource Data Store 328.

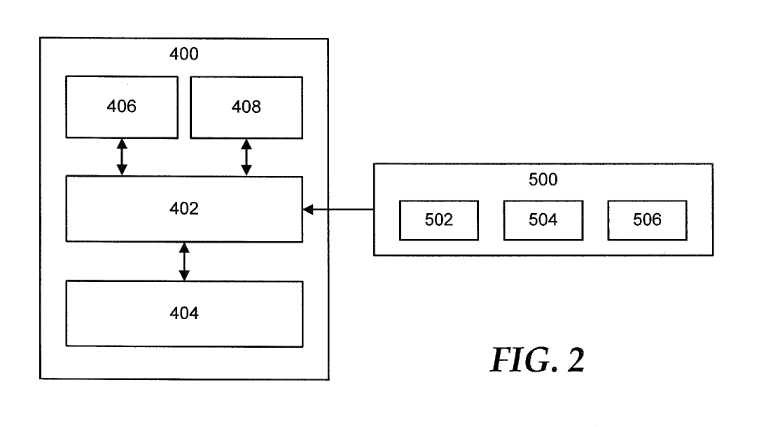

FIG. 2 shows a Record Display System 400 for displaying records captured by a PSRC system, such as PSRC system 100. Record Display System 400 can include a Simulation Logic 402, a Resource Replica 404, a User Interface Element Tree 406, and a User Data Replica 408. Record Display System 400 can provide access to a collection of records, including Description File 500. Access to the collection of records may be limited to displaying a record and may not include creating or editing a record. Description File 500 can include a Graphical Element Tree Description 502, a User Data Store 504, and an Application Resource Data Store 506 and can be stored either locally or at a remote storage server.

Simulation Logic 402 can connect and control Resource Replica 404, User Interface Element Tree 406, and User Data Replica 408. Additionally, Simulation Logic 402 can read data from Description File 500. When Description File 500 is stored at a remote storage, Simulation Logic 402 may retrieve Description File 500 from the remote storage. For example, Simulation Logic 402 can initiate a file transfer from the remote storage to a local storage. Further, Simulation Logic 402 can populate Resource Replica 404 with data from Application Resource Data Store 506, Simulation Logic 402 can populate User Interface Element Tree 406 with information from Graphical Element Tree Description 502, and Simulation Logic 402 can populate User Data Replica 408 with data from User Data Store 504.

Simulation Logic 402 can emulate the display environment of a record keeping application, such as Record Keeping Application 200, from which Description File 500 was captured. For example, Simulation Logic 402 can generate a user interface based on the information in User Interface Element Tree 406 and populate the user interface with data from User Data Replica 408 and Resource Replica 404. In a particular embodiment, Simulation Logic 402 can display an image, such as an X-ray image, within a drawing widget complete with scroll bars.

Additionally, Simulation Logic 402 can transform the data to present the record in a different format. For example, Simulation Logic 402 can generate a document, such as a postscript document or portable document format (PDF) document, including a listing of the information contained in Description File 500. The document may include the labels and data associated with text fields of User Interface Element Tree 406. The document may not include interactive elements such as buttons. Additionally, images associated with display widgets may be resized and scaled to fit within the document. The images can be inserted into the document without the use of scroll bars and other interactive elements associated with the display widget.

The previously described modules can be implemented in hardware, software, or any combination thereof. Each module may include one or more computer systems. When a module includes more than one computer system, the functions of the module can be distributed across the multiple computer systems in a symmetric manner, i.e., each computer system performs the same type of tasks, or in an asymmetric manner, i.e., two computer systems of the module may perform different tasks.

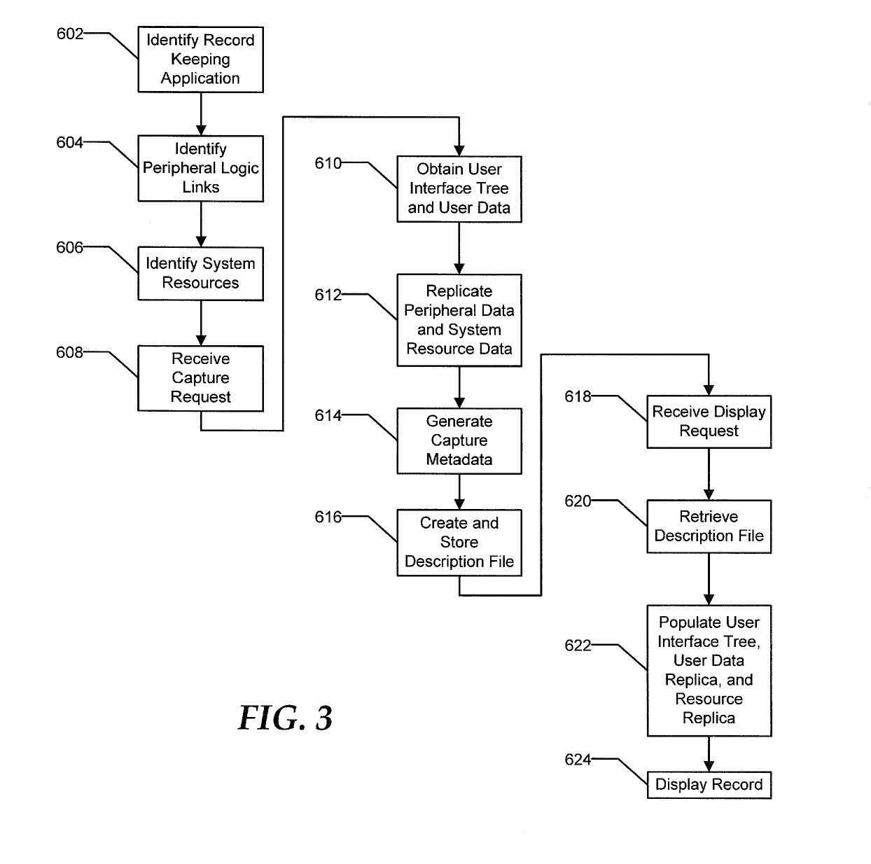

FIG. 3 illustrates an exemplary method of capturing and displaying electronic records. At 602, a PSRC system can identify a record keeping application. The record keeping application can provide access to records, such as medical records, financial records, legal records, education records, and the like. At 604, the PSRC system can identify peripheral logic links between the record keeping application and external hardware devices. External hardware devices can include scanners, printers, video cameras, external storages, and the like. At 606, the PSRC system can identify system resources associated with the record keeping application. System resources can include file systems, memory, network connections, clipboard data, and the like.

At 608, the PSRC system can receive a capture request. For example, a user can request the PSRC system to capture the record currently displayed by the record keeping application. At 610, the PSRC system can obtain user interface tree and user data. The user interface tree can include information about the hierarchical tree organization of the graphical elements, and the user data can contain application specific data associated with the graphical elements. At 612, the PSRC system can replicate peripheral data and system resource data. The replicated peripheral data can include data from peripheral logic links associated with the currently displayed record, and the replicated system resource data can include data from system resources associate with the currently displayed record. At 614, the PSRC system can generate capture metadata. The capture metadata can include a name associated with the record, the time and date the record was captured, an identifier for the record keeping application, an identifier for a user who initiated the capture, and the like. At 616, the PSRC system can create and store a description file. The description file can include the capture metadata, the user interface tree information, the user data, the replicated peripheral data and the replicated system resource data. The description file can be stored locally or at a remote storage server.

At 618, a record display system can receive a display request. The display request can identify a captured record to be displayed. At 620, the record display system can retrieve the description file for the captured record, such as from a local or remote storage. At 624, the record display system can populate a user interface tree, a user data replica, and a resource replica based on the information contained in the description file. At 626, the record display system can display the captured record. In an embodiment, the captured record can be displayed in a substantially similar format to the record keeping application. In an alternate embodiment, the record display system can transform the data and display the captured record in an alternate format.

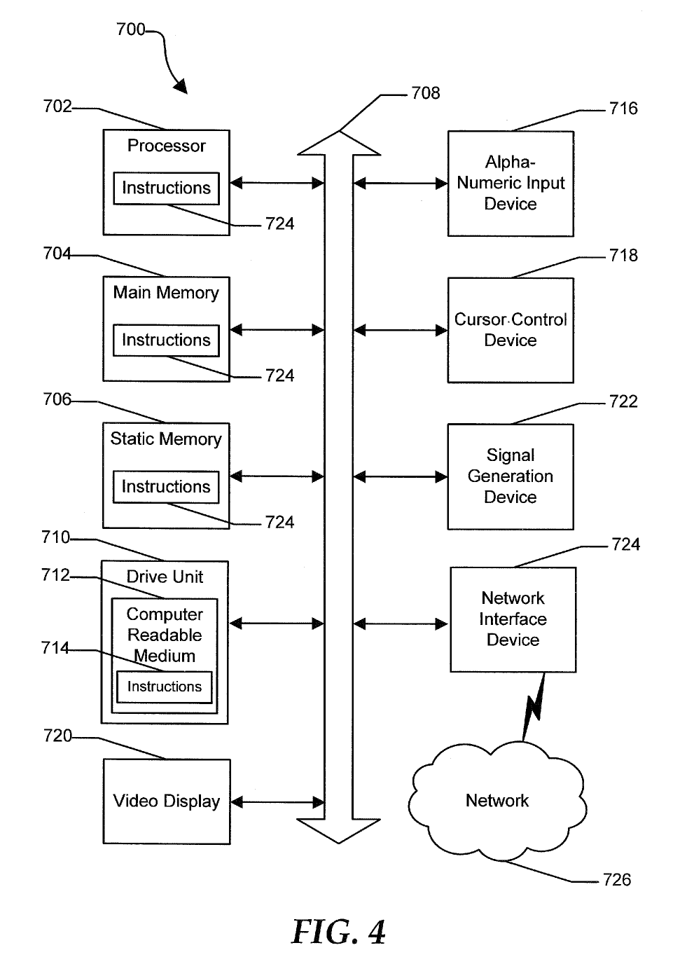

FIG. 4 shows an illustrative embodiment of a general computer system 700. Computer system 700 can include a set of instructions that can be executed to cause the computer system to perform any one or more of the methods or computer based functions disclosed herein.

Computer system 700 may include a processor 702, such as a central processing unit (CPU), a graphics processing unit (GPU), or both. Moreover, computer system 700 can include a main memory 704 and a static memory 706 that can communicate with each other via a bus 708. Computer system 700 can further include a disk drive unit 710. In a particular embodiment, disk drive unit 710 may include a computer-readable medium 712 in which one or more sets of instructions 714, such as software, can be embedded. Further, instructions 714 may embody one or more of the methods or logic as described herein. In a particular embodiment, instructions 714 may reside completely, or at least partially, within main memory 704, static memory 706, and/or within processor 702 during execution by computer system 700. Main memory 704 and processor 702 also may include computer-readable media.

As shown, computer system 700 may include an input device 716 such as a keyboard, and a cursor control device 718 such as a mouse. Additionally, computer system 700 may further include a video display unit 720 such as a liquid crystal display (LCD), an organic light emitting diode (OLED), a flat panel display, a solid-state display, or a cathode ray tube (CRT). Alternatively, input device 716 and cursor control device 718 can be combined in a touchpad or combined with video display unit 720 in a touch sensitive screen. Computer system 700 can also include a signal generation device 722 such as a speaker or remote control, and a network interface device 724 to communicate with a network 726.

Computer system 700 may operate as a standalone device or may be connected, such as by using a network, to other computer systems or peripheral devices. In a networked deployment, computer system 700 may operate in the capacity of a server or as a client user computer in a server-client user network environment, or as a peer computer system in a P2P (or distributed) network environment. Computer system 700 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a web appliance, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A system for capturing information associated with a target application, the system comprising:
a resource monitor configured to identify an internal resource associated with the target application;
a peripheral monitor configured to identify peripheral data passing from a peripheral device to the target application; and
a capture module configured to:
receive a graphical element descriptor and user data associated with the target application;
receive a replica of the internal resource or the peripheral data associated with the target application; and
generate a description file including the graphical element descriptor, the user data, the replica of the internal resource, the replica of the peripheral data, or any combination thereof.

2. The system of claim 1, wherein the capture module is further configured to store the description file.

3. The system of claim 1, further comprising a connector module configured to interface with the target application to obtain the graphical element descriptor and the user data; and provide the graphical element descriptor and the user data to the capture module.

4. The system of claim 1, wherein the capture module is further configured to transmit the description file to a remote storage server.

5. The system of claim 1, wherein the capture module is further configured to receive a request from a user to initiate a capture of a record from the target application.

6. The system of claim 1, further comprising an application monitor configured to identify the target application.

7. The system of claim 1, wherein the data record further includes metadata including a name associated with the record, the time and date the record was captured, an identifier for the target application, an identifier for the user who initiated the capture, a description of the record, or any combination thereof.

8. A computer readable medium comprising a plurality of instructions to manipulate a processor, the plurality of instructions comprising:
instructions to identify an internal resource associated with a target application;
instructions to identify a peripheral data connection from a peripheral device to the target application;
instructions to obtain a graphical element descriptor and user data associated with the target application;
instructions to obtain a replica of the internal resource or the peripheral data associated with the target application;
instructions to generate a description file including the graphical element descriptor, the user data, the replica of the internal resource, the replica of the peripheral data, or any combination thereof; and
instructions to store the description file.

9. The computer readable medium of claim 8, wherein the plurality of instructions further includes instructions to generate metadata associated with a record capture event, the metadata including a name associated with the record, the time and date the record was captured, an identifier for the target application, an identifier for the user who initiated the capture, a description of the record, or any combination thereof, and wherein the description file further includes the metadata associated with the record capture event.

10. The computer readable medium of claim 8, wherein the plurality of instructions further includes instructions to identify the target application based on a pre-defined list of applications, confirmation from a user, or any combination thereof.

11. The computer readable medium of claim 8, wherein the plurality of instructions further includes instructions to receive a request from a user to initiate a record capture event.

12. A computer readable medium comprising a plurality of instructions to manipulate a processor, the plurality of instructions comprising:
instructions to retrieve a description file for a captured record, the description file including a graphical element descriptor, user data, and a replica of an internal resource or peripheral data;
instructions to populate a user interface element tree with the graphical element descriptor, a user data replica with the user data, and a resource replica with the replica of the internal resource or the peripheral data;
instructions to generate a display of the captured record using the user interface element tree, the user data replica, and the resource replica; and
instructions to provide the display to a user.

13. The computer readable medium of claim 12, wherein the plurality of instructions further comprise instructions to receive a request to display the captured record, the request including an identifier for the description file.

14. The computer readable medium of claim 12, wherein the instructions to retrieve a description file include instructions to initiate a transfer of the description file from a remote server.

15. The computer readable medium of claim 12, wherein the instructions to generate a display include instructions to generate a document.

16. The computer readable medium of claim 12, wherein the instructions to generate a display include instructions to replicate a display of a target application from which the record was captured.
